(19) United States
(12) Patent Application Publication
(10) Pub. No.: US 2011/0090328 A1
(43) Pub. Date: Apr. 21, 2011

(54) PORTABLE MICROSCOPE

(76) Inventor: Hung-Chang Chen, Taipei (TW)

(21) Appl. No.: 12/701,154

(22) Filed: Feb. 5, 2010

(30) Foreign Application Priority Data
Oct. 20, 2009 (TW) 098219338

(51) Int. Cl. G02B 21/36; G02B 21/02; H04N 7/18

(52) U.S. Cl. 348/79; 359/383; 348/E07.085

(57) ABSTRACT

A portable microscope includes an image sensing module and an objective lens ascending/descending module. The objective lens ascending/descending module includes a rotatable roller, a sliding track member and an objective lens assembly. A first thread structure is formed on an inner wall of the rotatable roller. The sliding track member is disposed within the rotatable roller, and includes at least two parallel sliding tracks for defining a channel. The objective lens assembly is coupled to the sliding track member and slidable along the channel. A second thread structure mating with the first thread structure is formed on an external surface of the objective lens assembly. Upon rotation of the rotatable roller, the objective lens assembly is moved along the channel of the sliding track member, thereby adjusting the size of an image acquired by the image sensing module.

### FIELD OF THE INVENTION

The present invention relates to a portable microscope, and more particularly to a portable microscope with a stably movable objective lens.

### BACKGROUND OF THE INVENTION

For immediately observing a small object such as a skin epidermal cell, an iris, an ear canal, a tooth, jewel, a pin of an electronic component on a circuit board, a portable microscope is usually used to obtain an enlarged image of the object. The process of operating a portable microscope includes the following steps. Firstly, the portable microscope is in contact with the object to be observed. By adjusting the vertical position of an objective lens within the portable microscope, an enlarged image of the object is obtained. Afterwards, the image data of the enlarged image is transmitted to a monitor for display in order for facilitating observation.

A portable microscope is disclosed in, for example, U.S. Pat. No. 7,102,817 filed Jan. 19, 2006. The microscope of this disclosure has a telescopic tube assembly for adjusting the focal length and magnification of the objective lens device without the need of replacing the objective lens.

In the microscope of this disclosure, the telescopic tube assembly has two guiding rods. The guiding rods penetrate through corresponding mounting holes of the outer flange of the inner tube. The both ends of each guiding rod are respectively securely in the casing and the cap. The inner tube may be guided by the two guide rods to move upwards and downwards in the vertical direction, thereby changing the distance between the objective lens device and the object. Since the contact area between the guiding rods and the mounting holes of the outer flange of the inner tube is very small, the objective lens may sometimes fail to be smoothly moved during the process of adjusting the objective lens. In addition, if the supporting force is insufficient, the outer tube of the telescopic tube assembly may rotate due to the gravity force of the objective lens so as to affect the precision. Due to the difference between the geometric profiles of the tabs of the inner tube and the inner thread of the outer tube, the precision and stability of ascending/descending motion of the objective lens are usually unsatisfied.

### SUMMARY OF THE INVENTION

The present invention relates to a portable microscope. The portable microscope has a sliding track member comprising at least two parallel sliding tracks for guiding movement of an objective lens assembly. Since the male threads of the objective lens assembly mate with the thread trajectory of the outer tube, the objective lens assembly is precisely moved upon rotation of the rotatable roller. As a consequence, the precision and stability of moving the objective lens are both enhanced.

In an embodiment, the present invention provides a portable microscope. The portable microscope includes an image sensing module and an objective lens ascending/descending module. The objective lens ascending/descending module includes a rotatable roller, a sliding track member and an objective lens assembly. A first thread structure is formed on an inner wall of the rotatable roller. The sliding track member is disposed within the rotatable roller, and includes at least two parallel sliding tracks for defining a channel. The objective lens assembly is coupled to the sliding track member and slidable along the channel. A second thread structure mating with the first thread structure is formed on an external surface of the objective lens assembly. Upon rotation of the rotatable roller, the objective lens assembly is moved along the channel defined by the parallel sliding tracks of the sliding track member, thereby adjusting the size of an image acquired by the image sensing module.

In an embodiment, the portable microscope further includes a microscope upper portion connected to the objective lens ascending/descending module. A controlling circuit board is disposed within the microscope upper portion and electrically connected to the image sensing module.

In an embodiment, the controlling circuit board and the image sensing module are integrated into a single circuit board.

In an embodiment, the portable microscope further includes a height adjusting tube, which is connected to the objective lens ascending/descending module for defining a minimum distance between the objective lens assembly and an object to be observed.

In an embodiment, the objective lens ascending/descending module comprises an outer tube, which is a hollow cylindrical tube with a lateral opening. The rotatable roller is touchable through the lateral opening.

In an embodiment, the rotatable roller is sheathed with a rubber cover. When a user's finger rotates the rubber cover through the lateral opening, a friction force required for rotating the rotatable roller and a tactile feel are enhanced.

In an embodiment, a gliding groove is disposed on the outer tube to be connected with a main body of one of various holders. The sliding track member is accommodated within the outer tube. A first end of the sliding track member is fixed on a bottom of the outer tube.

In an embodiment, the outer appearance of the objective lens assembly is designed to comply with the cross-sectional profile of the channel of the sliding track member, so that the objective lens assembly is tight-fitted into and slidable along the channel of the sliding track member.

In an embodiment, the first thread structure includes a plurality of male threads, and the second thread structure includes a plurality of female threads.

In an embodiment, the first thread structure includes a plurality of female threads, and the second thread structure includes a plurality of male threads.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic exploded view illustrating a portable microscope according to an embodiment of the present invention;

FIG. 2 is a schematic assembled view illustrating the portable microscope of FIG. 1;

FIG. 3 is a schematic assembled view illustrating the portable microscope of FIG. 2 and taken from another viewpoint;

FIG. 4 is a schematic cross-sectional view illustrating the portable microscope of the present invention;

FIG. 5 is a schematic view taken from the bottom of a sliding track member of the portable microscope of the present invention;

FIG. 6A is schematic diagram illustrating a combination of a sliding track member and an objective lens assembly of the portable microscope of the present invention;

FIGS. 6B and 6C are schematic views illustrating movement of the objective lens assembly along the sliding track member;

FIG. 7 is a schematic diagram illustrating a lower portion of an outer tube of the portable microscope of the present invention; and

FIG. 8 is a schematic top view illustrating a main body of a holder connected with the portable microscope of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

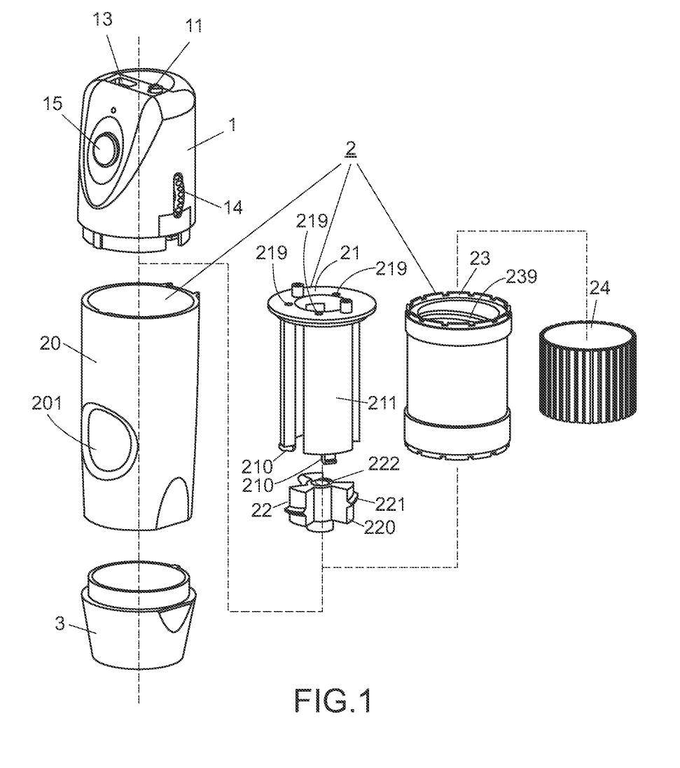

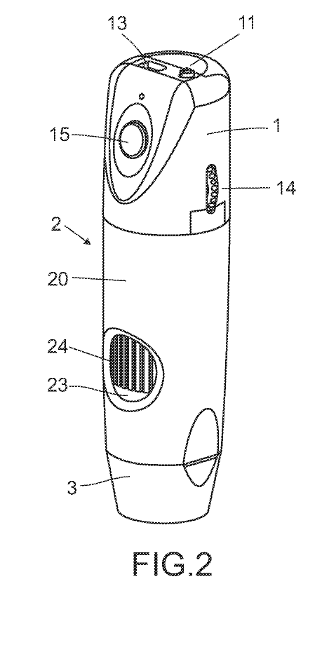

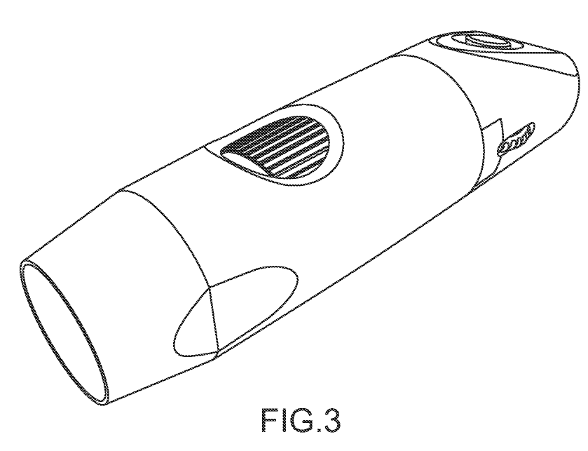

FIG. 1 is a schematic exploded view illustrating a portable microscope according to an embodiment of the present invention. FIG. 2 is a schematic assembled view illustrating the portable microscope of FIG. 1. FIG. 3 is a schematic assembled view illustrating the portable microscope of FIG. 2 and taken from another viewpoint. The portable microscope is used for observing a small object such as a skin epidermal cell, an iris, an ear canal, a tooth, jewel, and a pin of an electronic component on a circuit board. Please refer to FIGS. 1, 2 and 3. The portable microscope comprises a microscope upper portion 1, an objective lens ascending/descending module 2 and a height adjusting tube 3.

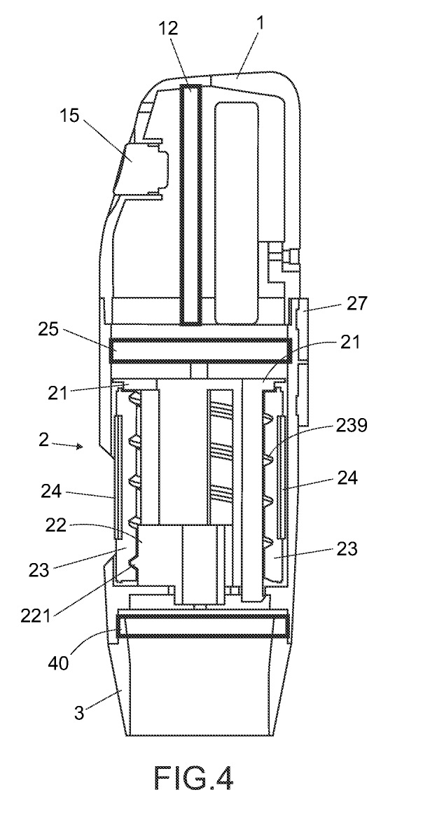

A controlling circuit board 12 is disposed in the microscope upper portion 1 (see the cross-sectional view of FIG. 4). By operating a power switch 11 on the outer surface of the microscope upper portion 1, the controlling circuit board 12 is controlled to enable the portable microscope. In addition, an image sensing module 25 (see the cross-sectional view of FIG. 4) is electrically connected to the controlling circuit board 12 for acquiring an image data of the object to be observed. By externally connecting a signal transmission wire (not shown) to the signal socket 13 and a computer (not shown), the image data of the object may be transmitted to a monitor of the computer. Alternatively, the image data of the object may be transmitted to a monitor of the computer according to a wireless transmission technology. The push button 15 has a function similar to a shutter button. By depressing the push button 15, the image of the object is captured and then transmitted to the computer. In some embodiments, the controlling circuit board 12 and the image sensing module 25 may be integrated into a single circuit board. The height adjusting tube 3 is connected to the objective lens ascending/descending module 2. The height adjusting tube 3 is used for defining a minimum distance between an objective lens assembly 22 of the objective lens ascending/descending module 2 and the object. The external appearance of the height adjusting tube 3 is substantially a transparent cone with a downwardly tapered diameter.

Moreover, the objective lens ascending/descending module 2 is connected to the image sensing module 25 in order for adjusting the shooting area of the image sensing module 25 to capture the image data. Please refer to the exploded view of FIG. 1 again. The objective lens ascending/descending module 2 comprises an outer tube 20, a sliding track member 21, an objective lens assembly 22 and a rotatable roller 23. As shown in FIG. 1, the outer tube 20 is a hollow cylindrical tube with a lateral opening 201. The rotatable roller 23 is sheathed with a rubber cover (sleeve with striped pattern) 24. The user's finger may touch the rubber cover 24 through the lateral opening 201. Due to the rubber cover 24, the friction force required to rotate the rotatable roller 23 and the tactile feel are both enhanced.

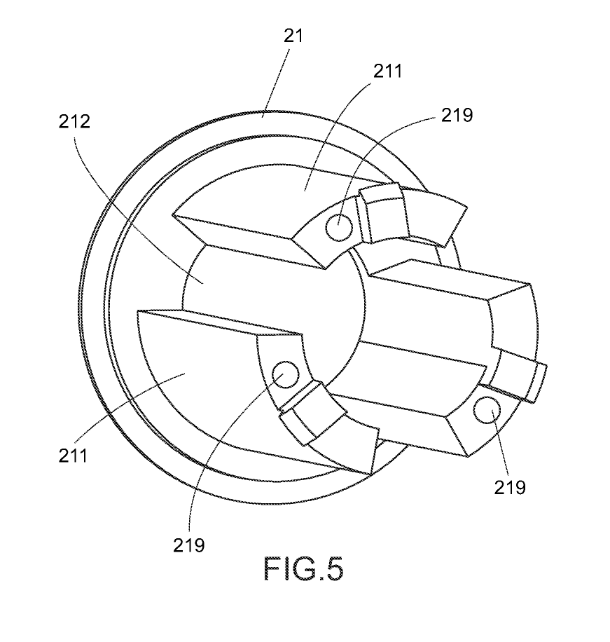

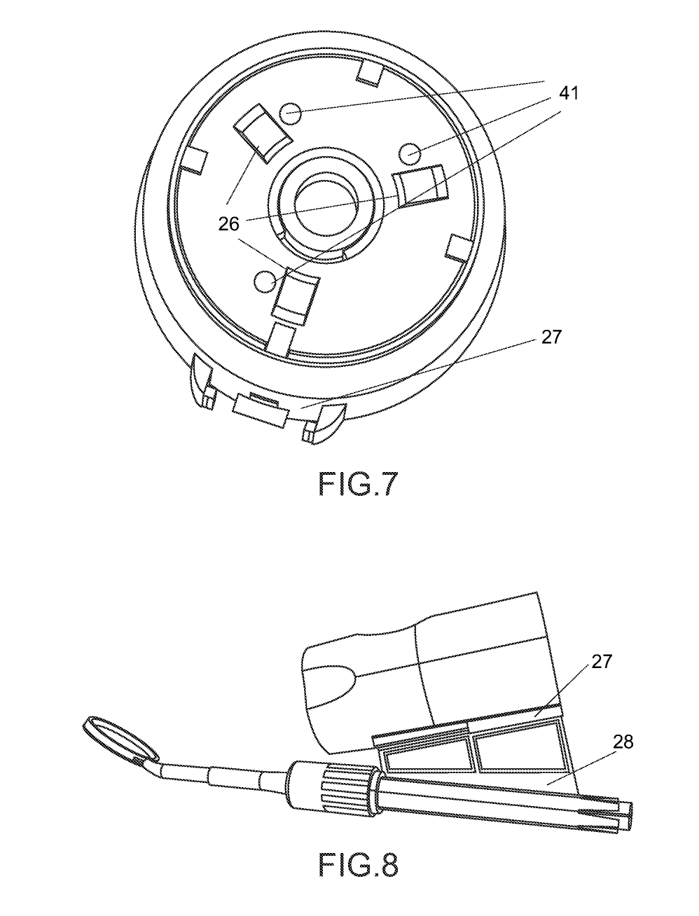

The sliding track member 21 shown in FIG. 5 is accommodated within the outer tube 20. A first end of the sliding track member 21 is fixed on the bottom of the outer tube 20. For example, several tenons 210 are formed on the first end of the sliding track member 21 (see FIG. 1), and several tenon insertion slots 26 are formed in the bottom of the outer tube 20 (see FIG. 7). The tenons 210 are engaged with corresponding tenon insertion slots 26, so that the first end of the sliding track member 21 is fixed on the bottom of the outer tube 20. In addition, the image sensing module 25 is fixed on the second end of the sliding track member 21. The sliding track member 21 has several holes 219. The power wires 41 for controlling light sources (not shown) pass through the holes 219.

The objective lens assembly 22 is designed to have a group of various optical lenses 222 according to the observing requirements. The outer appearance of the objective lens assembly 22 is designed to comply with the cross-sectional profile of the internal channel of the sliding track member 21. Hence, the objective lens assembly 22 can be tight-fitted in the channel of the sliding track member 21 and coupled to the sliding track member 21

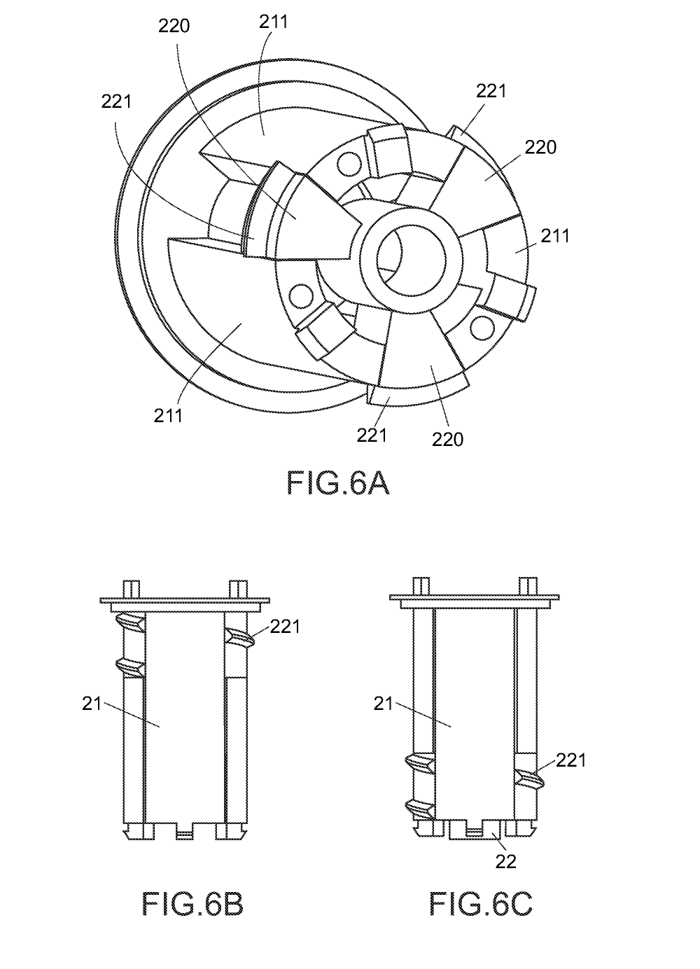

As shown in FIGS. 6A, the sliding track member 21 comprises three parallel tracks 211 and three notches 212. The outward appearance of the objective lens assembly 22 comprises three protrusions 220. The three protrusions 220 are embedded into corresponding notches 212, so that the objective lens assembly 22 is tight-fitted into the internal channel of the sliding track member 21. In addition, the objective lens assembly 22 is able to move along the internal channel of the sliding track member 21 upwardly and downwardly. Male threads 221 are formed on the outer peripheries of the protrusions 220, and female threads 239 are formed in the inner wall of the rotatable roller 23. The male threads 221 mate with the female threads 239. Upon rotation of the rotatable roller 23, the objective lens assembly 22 carrying the lens 222 can be precisely moved along the internal channel of the sliding track member 21 upwards and downwards. FIG. 6B illustrates that the objective lens assembly 22 is positioned against the top of the sliding track member 21. On the other hand, FIG. 6C illustrates that the objective lens assembly 22 is moved downwards and partially exposed from the sliding track member 21. Generally, the vertical displacement depends on thread pitch of the inner threads of the rotatable roller 23. Moreover, since the protrusions 220 are tight-fitted into corresponding notches 212, the possibility of rocking the objective lens assembly 22 toward the left and right sides will be minimized, and thus the drawbacks encountered from the prior art is obviated. Alternatively, the locations of the male threads 221 and the female threads 239 may be exchanged. That is, male threads are formed in the inner wall of the rotatable roller 23, and female threads are formed on the outer peripheries of the protrusions 220.

In some embodiments, as shown in FIG. 8, the upper portion of the outer tube 20 further includes a gliding groove 27. Via the gliding groove 27, the main body of a holder 28 (e.g. a mouth mirror holder) may be connected with the portable microscope of the present invention. Hence, the portable microscope may be cooperated with a mouth mirror to observe oral cavity or teeth of patients.

Please refer to FIG. 4 again. A light source 40 is optionally provided in the lower portion of the outer tube 20. An example of the light source 40 includes a set of light emitting diodes. The power wires 41 (see FIG. 7) pass through the sliding track member 21 and are connected to the image sensing module 25, which is disposed over the objective lens ascending/descending module 2. By operating the power switch 11 on the microscope upper portion 1, the light source 40 is turned on or off. In addition, the brightness of the light beam emitted from the light source 40 is adjustable by turning a knob 14 of the microscope upper portion 1.

From the present invention, the portable microscope of the present invention is capable of enhancing the precision and stability of adjusting the height of the objective lens.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable microscope comprising:
an image sensing module; and
an objective lens ascending/descending module comprising:
a rotatable roller, wherein a first thread structure is formed on an inner wall of the rotatable roller;
a sliding track member disposed within the rotatable roller, and comprising at least two parallel sliding tracks for defining a channel; and
an objective lens assembly coupled to the sliding track member and slidable along the channel, a second thread structure mating with the first thread structure being formed on an external surface of the objective lens assembly, wherein upon rotation of the rotatable roller, the objective lens assembly is moved along the channel of the sliding track member, thereby adjusting the size of an image acquired by the image sensing module.

2. The portable microscope according to claim 1, further comprising a microscope upper portion connected to the objective lens ascending/descending module, wherein a controlling circuit board is disposed within the microscope upper portion and electrically connected to the image sensing module.

3. The portable microscope according to claim 1 wherein the controlling circuit board and the image sensing module are integrated into a single circuit board.

4. The portable microscope according to claim 1, further comprising a height adjusting tube, which is connected to the objective lens ascending/descending module for defining a minimum distance between the objective lens assembly and an object to be observed.

5. The portable microscope according to claim 1 wherein the objective lens ascending/descending module comprises an outer tube, which is a hollow cylindrical tube with a lateral opening, wherein the rotatable roller is touchable through the lateral opening.

6. The portable microscope according to claim 5 wherein the rotatable roller is sheathed with a rubber cover, and the user rotates the rubber cover through the lateral opening

7. The portable microscope according to claim 5 wherein a gliding groove is disposed on the outer tube to be connected with a main body of a holder.

8. The portable microscope according to claim 5 wherein the sliding track member is accommodated within the outer tube, and a first end of the sliding track member is fixed on a bottom of the outer tube.

9. The portable microscope according to claim 1 wherein the outer appearance of the objective lens assembly is designed to comply with the cross-sectional profile of the channel of the sliding track member, so that the objective lens assembly is tight-fitted into the channel and slidable along the channel.

10. The portable microscope according to claim 1 wherein the first thread structure includes a plurality of male threads, and the second thread structure includes a plurality of female threads.

11. The portable microscope according to claim 1 wherein the first thread structure includes a plurality of female threads, and the second thread structure includes a plurality of male threads.
